(19) United States
(12) Patent Application Publication
(10) Pub. No.: US 2004/0039557 A1
(43) Pub. Date: Feb. 26, 2004

(54) Method for characterising the compactness of objects such as cigarettes or filters

(76) Inventor: Stephane Colard, Orleans (FR)

Correspondence Address: William A Drucker, 1299 Pennsylvania Avenue NW, Washington, DC, 20004, US

(21) Appl. No.: 10/332,343

(22) PCT Filed: Jun. 28, 2001
(86) PCT No.: PCT/FR01/02077

(30) Foreign Application Priority Data
Jul. 13, 2000 (FR) 00 09366

(51) Int. Cl. G06G 7/48

(52) U.S. Cl. 703/5; 702/33

(57) ABSTRACT

The invention concerns a method which consists in: obtaining a physical model of phenomena involved when an object or product is subjected to a crushing test, said modelling taking into account elastic deformation, plastic deformation and relaxation; adjusting said model to experimental data and characterising the object or product from the adjusted model by means of parameters other than the crushing amplitude value, relative to energy dissipation during deformation, load relaxation or even energy accumulation during deformation. The invention enables to obtain more discriminating and more descriptive data concerning mechanical properties of the objects or products.

The present invention concerns a method for characterising the compactness of objects, such as cigarettes or filters, as well the capacity to fill a volume by products, such as tobacco.

Generally speaking, it is known that the current methods for characterising the compactness of cigarettes, filters and the filling capacity are based on a given physical principle : the product to be characterised is placed between two jaws which submit it to a force able to provoke crushing. The amplitude of the resultant deformation is then measured after a certain time and is directly linked to the characteristic properties, namely compactness and filling capacity. Current methods therefore assimilate these characteristic properties with a crushing amplitude.

The shape of the jaws, the value of the force applied and the time at the end of which the crushing amplitude is measured significantly vary from one device supplier to another, but the principle remains the same.

The characterisation of the compactness or filling capacity by means of crushing amplitude constitute a simple means, but this is far from providing a detailed description of the behaviour of the product when it is subjected to a force. In fact, crushing depends on the elastic and plastic deformations and the relaxing of forces inside the product. Now, the crushing amplitude after a given time provides no information concerning these three physical phenomena. Thus, current methods are scarcely discriminating and are thus less descriptive of the mechanical properties of the product.

Thus, the object of the invention is more particularly to eliminate these drawbacks.

To this effect, it concerns a characterisation method based on a physical modelisation of the phenomena and the adjustment of this model to experimental data so as to characterise the product as regards the compactness or filling capacity.

More specifically, this method includes the following stages

The physical modelisation of the phenomena forming part of the crushing process, this modelisation taking into account elastic deformation, plastic deformation and relaxation.

The adjustment of the model obtained during the experimental data modelisation phase, and

The characterisation of the product from the adjusted model by means of parameters, other than the crushing amplitude value, relating to the dissipation of energy during deformation, the relaxation of forces or even the accumulation of energy during deformation.

Advantageously, said adjustment phase could include:

The application to the product of a known crushing force with the aid of a device including jaws, a device for applying a force to these jaws and a system for recording the relative movement of said jaws,

A data acquisition phase in which the movement over a period of time is recorded,

A physical characterisation phase by the adjustment of the model to the experimental data by using a multiregression tool,

A phase for describing the product with the aid of at least three parameters characteristic of the plastic and elastic deformation and the relaxation phenomenon.

It is to be noted that this method, which provides information relating to elastic deformation, plastic deformation and relaxation during the crushing process is more discriminating than those methods used to date.

In addition, according to this method, the information is extracted from the first seconds of crushing and is thus obtained much quicker than it is with current methods based on crushing amplitude measurements.

The method of the invention shall be more readily understood from a reading of the description given hereafter by way of non-restrictive example with reference to the accompanying drawings on which:

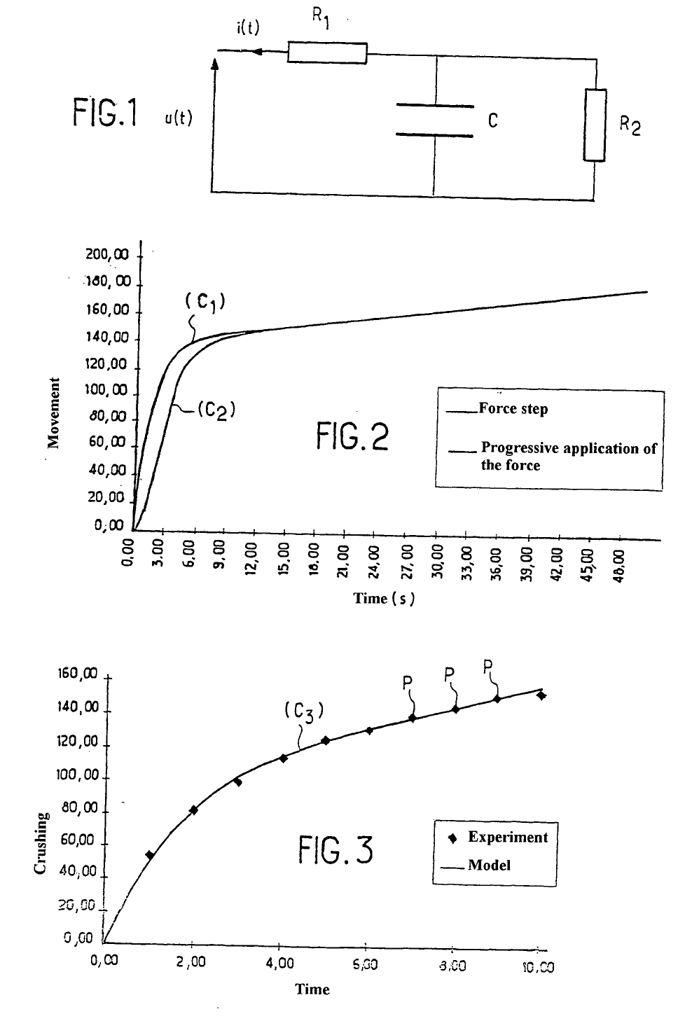

FIG. 1 is a diagram of an electric circuit constituting a model of the behaviour of a cigarette or a tobacco sample subjected to a crushing force;

FIG. 2 is a diagram showing the time-controlled movement modelisation curves of the jaw crushing the cigarette or tobacco sample to which the crushing force is applied;

FIG. 3 shows a time-controlled crushing curve illustrating the adjustment of the model to the crushing measurements recorded experimentally.

As mentioned previously, the method of the invention includes the modelisation of the behaviour of the object to be examined and subjected to a crushing force.

To this effect, the Applicant has searched similar cases which may exist between the physical phenomena implemented in the crushing process and the electric phenomena whose laws are well known and thus able to be exploited easily.

In this respect, this modelisation is based on the following facts

plastic deformation, which induces a loss of energy provided, can be represented by an electric resistor R₁ which dissipates the energy when a current traverses it, elastic deformation, which represents a storage of energy, can be represented by a capacitor C which is charged or discharged when it is subjected to voltage variations,

relaxation, which constitutes an accumulated loss of energy, can be represented by a resistor R₂ connected in parallel from the capacitor inducing a leakage current.

Table I hereafter shows the analogies between the previously mentioned mechanical phenomena and the electric phenomena.

TABLE I

| Mechanical properties | Electric phenomena |
|---|---|
| Force F (t) | Voltage u (t) |
| Speed v (t) | Current i (t) |
| $\begin{matrix}Energy supplied \text{:} \\ {\int }_{a}^{t} F ( t ) \cdot v ( t ) \cdot ⅆ t\end{matrix}$ | $\begin{matrix}Energy supplied \text{:} \\ {\int }_{o}^{t} u ( t ) \cdot i ( t ) \cdot ⅆ t\end{matrix}$ |
| Energy dissipation | $\begin{matrix}Resistor R \text{:} \\ {\int }_{a}^{t} R \cdot {I}^{2} ( t ) \cdot ⅆ t\end{matrix}$ |
| Energy accumulation | $Capacitor \frac{1}{2} \times C \times {u}^{2} ( t )$ |

The electric model equivalent to an object, such as a cigarette, filter or a tobacco sample, subjected to a crushing force is shown on FIG. 1.

This model appears in the form of an electric circuit mounted between two terminals to which a voltage u(t) is applied and including in series a resistor R₁ and a capacitor C on which a resistor R₂ is mounted in parallel.

Calculation of the response of a cigarette or tobacco to a force F(t) boils down to calculating the response of the electric circuit to a voltage u(t). Generally speaking, this calculation can be carried out using the Laplace transformation.

By assuming that the amplitude force F is applied instantaneously, that is when the voltage u(t) is a voltage step, the current i(t) circulating in the resistor R₁ is as specified below:

$$i ( t ) = \frac{U}{{R}_{1}} [ 1 - \frac{{R}_{2}}{{R}_{1} + {R}_{2}} \times ( 1 - {ⅇ}^{- \frac{{R}_{1} + {R}_{2}}{{R}_{1} \times {R}_{2} \times C} \times t} ) ]$$

namely by analogy for the moving speed:

$$v ( t ) = \frac{F}{{p}_{1}} [ 1 - \frac{{p}_{2}}{{p}_{1} + {p}_{2}} \times ( 1 - {ⅇ}^{- \frac{{p}_{1} + {p}_{2}}{{p}_{1} \times {p}_{2} \times {p}_{3}} \times t} ) ]$$

and for movement:

$$ⅆ ( t ) = {\int }_{0}^{t} v ( t ) \cdot ⅆ t ≡ {\int }_{0}^{t} i ( t ) \cdot ⅆ t$$

$$ⅆ ( t ) = \frac{{F}_{\cdot } {p}_{2 \cdot }^{2} {p}_{3}}{{( {p}_{1} + {p}_{2} )}^{2}} \times ( 1 - {ⅇ}^{- \frac{{p}_{1} + {p}_{2}}{{p}_{1 \cdot } {p}_{2 \cdot } {p}_{3}} \times t} ) + \frac{F}{{p}_{1} + {p}_{2}} \times t$$

With p₁: parameter characteristic of the dissipation of energy during deformation

p₂: parameter characteristic of the relaxation of forces

p₃: parameter characteristic of the accumulation of energy during deformation.

The electric model referred to above makes it possible to calculate the movement irrespective of the force applied. Here is another example : if one assumes that the force F(t) is not applied instantaneously but increases linearly before reaching its maximum value F at the end of a time tₒ, a more complex equation is obtained:

$$ⅆ ( t ) = \frac{a \times {p}_{1} \times {p}_{2}^{3} \times {p}_{3}^{2}}{{( {p}_{1} + {p}_{2} )}^{3}} \times ( {ⅇ}^{\frac{{p}_{1} + {p}_{2}}{{p}_{1 \cdot } {p}_{2 \cdot } {p}_{3}} \times t} - 1 ) + \frac{a}{2 \cdot ( {p}_{1} + {p}_{2} )} \times {t}^{2} + \frac{a \times {p}_{2}^{2} \times {p}_{3}}{{( {p}_{1} + {p}_{2} )}^{2}} \times t - [ \frac{a \times {p}_{1} \times {p}_{2}^{3} \times {p}_{3}^{2}}{{( {p}_{1} + {p}_{2} )}^{3}} \times ( {ⅇ}^{\frac{{p}_{1} + {p}_{2}}{{p}_{1 \cdot } {p}_{2 \cdot } {p}_{3}} \times ( t - {t}_{0} )} - 1 ) + \frac{a}{2 \cdot {p}_{1} + {p}_{2}} \times {( t - {t}_{0} )}^{2} + \frac{a \times {p}_{2}^{2} \times {p}_{3}}{{( {p}_{1} + {p}_{2} )}^{2}} \times ( t - {t}_{0} ) ] \times H \times ( t - {t}_{0} )$$

With a: Speed of increase of the voltage between t=0 and t=t₀ (a=F/t₀)H(t): Heaviside or step function

The modelisation of the movement is plotted for the two cases of the figure, for F=355, p₁=4, p₂=400, p₃=0.4 and t₀=3s on FIG. 2 in which the curve C, corresponds to the application of a force step, whereas the curve C₂ is the response to a progressive force application.

FIG. 2 shows that, after a major deformation, the relaxation phenomenon induces a linear movement.

Once the model has been set up, the latter can be exploited to characterise the product.

The experimental device used remains the same as those already used by current methods for measuring the compactness or filling capacity. On the other hand, with the method proposed, it is essential to know or record the force applied and the movement throughout the crushing process. Being aware of the force applied during the time, the theoretical movement is then simulated using the model which is adjusted to the measurement movement. However, it is necessary to state that a law of applying a single force, such as a force step, considerably simplifies the modelisation of the movement and thus the adjustment stage.

The exploitation of the data is thus made by adjusting the theoretical model to the experimental data. The adjustment of the theoretical model to the experimental data is effected using a non-linear multiregression computer tool. This tool can be based on various minimisation algorithm, such as the Newton Raphson one, of the largest slope or the Levenberg-Marquardt algorithm. In this latter case, it is possible to express the uncertainty concerning the three parameters p₁, p₂ and p₃ of the model. One example is given on FIG. 3 where a force step is applied and for which the measurements recorded are indicated on the table II below.

TABLE II

| Time | Crushing |
|---|---|
| 0.00 | 0.00 |
| 1.00 | 55.20 |
| 2.00 | 82.20 |
| 3.00 | 98.70 |
| 4.00 | 113.90 |
| 5.00 | 125.70 |
| 6.00 | 131.60 |
| 7.00 | 139.80 |
| 8.00 | 145.70 |
| 9.00 | 151.60 |
| 10.00 | 154.40 |

On FIG. 3, the curve C₃ corresponds to the model, whereas the points P correspond to the values obtained experimentally.

The values of the parameters of the model allowing adjustment of the experimental data are 95% the following:

p₁=4.4±0.2

p₂=48±5

p₃=0.40±0.01

with F=300

These three parameters characterise the behaviour of the product when the latter is subjected to crushing.

p₁ is a parameter relating to plastic deformation. The larger said parameter is, the more significant the plastic deformation is. p₂ is a parameter relating to relaxation. The larger said parameter p₂ is, the weaker the phenomenon is. Finally, p₃ is a parameter relating to elastic deformation. The larger said parameter p₃ is, the more significant the elastic deformation is.

These three parameters, obtained by means of a new measuring method, make it possible to characterise the product more completely than a crushing amplitude value after a given period of time. In addition, the new method is able to calculate a posteriori the result which would be given by current methods. The opposite case is false. This clearly demonstrates the most descriptive nature of the method of the invention.

Uncertainty concerning the parameters can be reduced by increasing the number of measurements.

1. Method for characterising the compactness of objects, such as cigarettes or filters, as well the capacity to fill a volume by a product, such as tobacco, characterised in that it comprises the following stages:
the physical modelisation of phenomena involved in the process for crushing the object or product, this modelisation taking into account elastic deformation, plastic deformation and relaxation.
the adjustment of the model obtained during the modelisation stage with experimental data, and
the characterisation of the object or product from the adjusted model by means of parameters other than the crushing amplitude value and relating to the dissipation of energy during deformation, the relaxing of forces or even the accumulation of energy during deformation.

2. Method according to claim 2, characterised in that the model used is that of an electric circuit mounted between two terminals to which a voltage u(t) is applied and comprising in series firstly a resistor RI, and secondly a capacitor on which a resistor R2 is mounted in parallel.

3. Method according to one of the preceding claims, characterised in that said adjustment and characterisation states comprise:
the application to the product of a known crushing force using a device including jaws, a device for applying a force to these jaws and a system for recording a relative movement of said jaws,
a data acquisition stage in which the movement is recorded over a period of time,
a physical characterisation stage via the adjustment of the model using experimental data with the aid of a multiregression tool,
a stage for describing the product with the aid of at least three parameters characteristic of plastic deformation, elastic deformation and the relaxation phenomenon.

4. Method according to the preceding claims, characterised in that, in the case of applying a force step of amplitude F, said model is as specified below:
$$ⅆ ( t ) = \frac{{F}_{\cdot } {p}_{2 \cdot }^{2} {p}_{3}}{{( p1 + p2 )}^{2}} \times ( 1 - {ⅇ}^{\frac{{p}_{1} + {p}_{2}}{{p}_{1 \cdot } {p}_{2 \cdot } {p}_{3}} \times t} ) + \frac{F}{{p}_{1} + {p}_{2}} \times t$$
With p₁: parameter characteristic of the dissipation during deformation
p₂: parameter characteristic of the relaxing of forces
p₃: parameter characteristic of the accumulation of energy during deformation
d(t): time-dependent movement
F: maximum value of the force applied F(t)

5. Method according to claim 3, characterised in that the adjustment of said model with the experimental data is embodied with the aid of a non-linear multiregression computer tool based on a multiregression algorithm, such as the Newton Raphson algorithm with a larger slope or the Levenberg-Marquardt algorithm making it possible to express the uncertainty concerning the three parameters p₁, p₂ and p₃ of the model.
